(19) United States
(12) Patent Application Publication
(10) Pub. No.: US 2009/0064338 A1
(43) Pub. Date: Mar. 5, 2009

(54) PROXIMITY SENSITIVE BLADE SERVER SECURITY

(75) Inventors: Keith M. Campbell, Cary, NC (US); Raymond T. Greggs, Raleigh, NC (US); James G. McLean, Fuquay-Varina, NC (US); Caroline M. Metry, Cary, NC (US); Edward S. Suffern, Chapel Hill, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/846,553

(22) Filed: Aug. 29, 2007

(51) Int. Cl. G06F 7/04

(52) U.S. Cl. 726/26

(57) ABSTRACT

Embodiments of the present invention address deficiencies of the art in respect to blade server security and provide a method, system and computer program product for proximity sensitive blade server security. In one embodiment of the invention, a method for proximity sensitive blade server security can be provided. The method can include sensing proximity of a systems administrator relative to a blade center, detecting a loss of proximity of the systems administrator, and triggering automated securing of at least one blade server in the blade server in response to detecting the loss of proximity. For example, sensing proximity of a systems administrator relative to a blade center can include establishing a wireless radio connection with a personal article associated with the systems administrator, and determining a loss of proximity when the connection is lost.

### BACKGROUND OF THE INVENTION

1. Field of the Invention

The present invention relates to the field of blade computing and more particularly to blade server security.

2. Description of the Related Art

The data center has changed over time from a mainframe centric environment requiring dozens of skilled technologists to ensure the ongoing operation of the mainframe, to a complex environment of many different server computing platforms coupled to one another over sophisticated data communications networks. Initially a resource only available to the wealthiest of organizations, recent advances in the mass production of personal computers has provided access to data center technologies at a reasonable cost. Generally facilitated by a rack, the modern data center involves the arrangement of a multiplicity of personal computers in one or more racks coupled together according to conventional network protocols.

Access to the data center resource for the average organization is not without its cost. In particular, the arrangement of multiple computing platforms in a rack environment exposes the data center to many points of failure requiring substantial redundancy in hardware resources. Additionally, the sheer energy consumption by a cluster of computing hosts in a data center can become noticeably large. The physical consumption of space in the data center by an arrangement of computers can result in a nearly unmanageable environment. All told, the arrangement of ordinary computers in a rack environment within the data center can be unwieldy and an undesirable management challenge.

Addressing the unwieldy and unreliable nature of rack-mounted ordinary computers, blade server solutions have become pervasive in more sophisticated data centers. In the blade center environment, different computing platforms can be arranged into blades and coupled to one another across a mid-plane in a single chassis. The mid-plane can provide access to a unified power source, input output (I/O) devices and even removable media drives. In this way, the blades need not include or manage a power supply or commonly used drives within the blades themselves resulting in substantial power savings, a reduced footprint and overall lower total cost of ownership. Additionally, failover concerns can be met through the hot-swappable nature of the blades in the chassis.

Though a systems administrator can manage each blade in the chassis from a single location, managing each blade is not without consequence. Specifically, the systems administrator still is required to log into each operating system executing within each blade in order to administer the blade and its supported applications. Conversely, when the system administrator physically moves away from the chassis, the systems administrator likewise must log off or lock each operating system executing within each blade to preserve a secure environment. Alternatively, the systems administrator can rely upon the automated activation of a screen saver though the lapse of time between the departure of the systems administrator and the automated activation of the screen saver can give rise to a security vulnerability.

### BRIEF SUMMARY OF THE INVENTION

Embodiments of the present invention address deficiencies of the art in respect to blade server security and provide a novel and non-obvious method, system and computer program product for proximity sensitive blade server security. In one embodiment of the invention, a method for proximity sensitive blade server security can be provided. The method can include sensing proximity of a systems administrator relative to a blade center, detecting a loss of proximity of the systems administrator, and triggering automated securing of at least one blade server in the blade server in response to detecting the loss of proximity. For example, sensing proximity of a systems administrator relative to a blade center can include establishing a wireless radio connection with a personal article associated with the systems administrator, and determining a loss of proximity when the connection is lost.

In one aspect of the embodiment, triggering automated securing of at least one blade server in the blade server in response to detecting the loss of proximity can include triggering automated activation of a screen saver in at least one operating system supported by the at least one blade server in the blade server in response to detecting the loss of proximity. By comparison, in another aspect of the embodiment, triggering automated securing of at least one blade server in the blade server in response to detecting the loss of proximity, can include triggering an automated logoff of the systems administrator from at least one operating system supported by the at least one blade server in the blade server in response to detecting the loss of proximity.

In another embodiment of the invention, a blade center can be configured for proximity sensitive blade server security. The blade center can include a blade chassis supporting a plurality of blade servers, and a proximity detector. The proximity detector can include program code enabled to sense proximity of a systems administrator relative to the blade center, to detect a loss of proximity of the systems administrator, and to trigger automated securing of at least one of the blade servers in response to detecting the loss of proximity. For instance, the proximity detector can include a short range radio frequency transceiver configured to establish and maintain a short range radio frequency communications link with a personal article. One such short range radio frequency transceiver can include a Bluetooth transceiver. The personal article, in turn, can include an ear piece, a computing device such as a laptop computer or a personal digital assistant (PDA), or a cellular telephone to name only a few exemplary articles.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for proximity sensitive blade server security;

FIG. 2 is a schematic illustration of a blade server data processing system configured for proximity sensitive blade server security; and,

FIG. 3 is a flow chart illustrating a process for proximity sensitive blade server security.

### DETAILED DESCRIPTION OF THE INVENTION

Embodiments of the present invention provide a method, system and computer program product for proximity sensitive blade server security. In accordance with an embodiment of the present invention, a proximity of a systems administrator and a blade center including a chassis and one or more blade servers can be determined. As the proximity changes according to the movement of the systems administrator, it can be determined whether or not the systems administrator has left the vicinity of the blade center. If so, a message can be posted to each blade server in the blade center responsive to which each blade server can be secured. In this way, the systems administrator need not engage in a tedious manual securing of each blade server in the blade center.

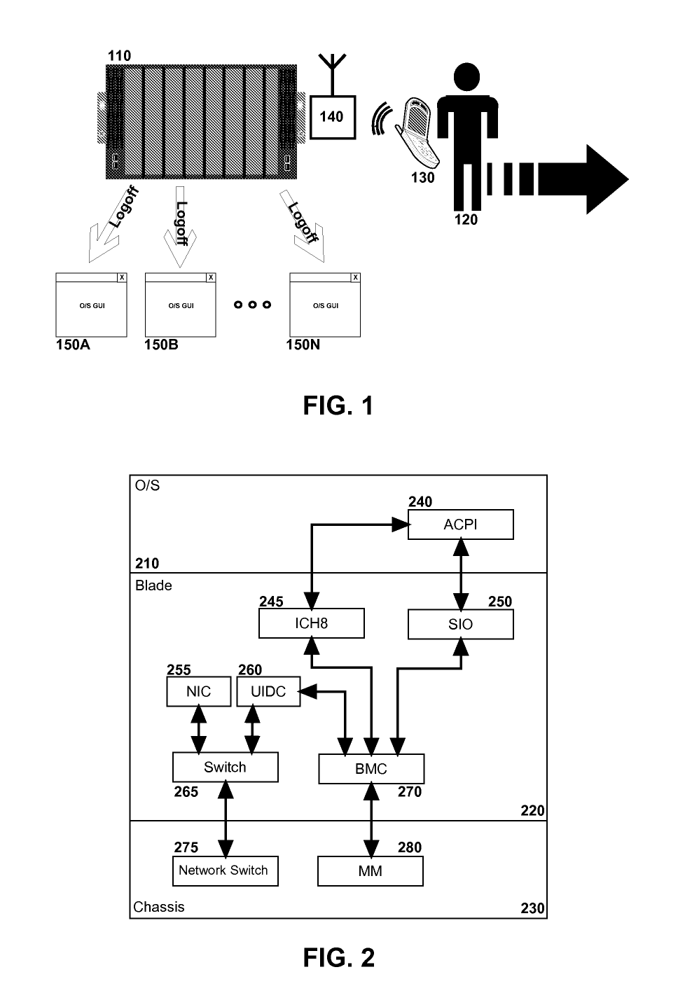

In illustration, FIG. 1 pictorially depicts a process for proximity sensitive blade server security. As shown in FIG. 1, a blade center 110 can be managed by a systems administrator 120 in proximity to the blade center 110. As part of managing the blade center 110, the systems administrator 120 can access each operating system 150A, 150B, 150N for each blade server in the blade center 110. Notably, the blade center 110 can be coupled to a proximity sensor 140 configured to detect a proximity of the system administrator 120 to the blade center 110. For example, a short range wireless radio communications link such as a Bluetooth connection can be established as between the proximity sensor 140 and a personal article 130, for example a dongle, earpiece, personal digital assistant (PDA) or cell phone, associated with the systems administrator 120.

Once the communications link has been established as between the systems administrator 120 and the blade center 110, the movement of the systems administrator 120 out of proximity of the blade center 110 can be detected. Responsive to detecting a threshold loss of proximity between the systems administrator 120 and the blade center 110, the proximity detector 140 can trigger the signaling of each operating system 150A, 150B, 150N to secure a corresponding blade server in the blade center 110. For example, a logout signal can be triggered in each of operating system 150A, 150B, 150N, or a screen saver activation signal can be triggered in each of operating system 150A, 150B, 150N. In any case, the systems administrator 120 is relieved of the burden of manually securing each blade server in the blade center 110 before moving from the proximity of the blade center 110.

In further illustration, FIG. 2 is a schematic illustration of a blade center configured for proximity sensitive blade server security. The blade center can include a chassis 230 supporting multiple different blade servers 220, each having at least one operating system 210. Each operating system 210 can support an advanced configuration and power interface (ACPI) 240 to provide access to power management functionality including logging off the operating system 210 and activating screensaver logic to secure by way of password protection access to the supporting blade server 220.

Each blade server 220 can be communicatively coupled to the ACPI 240 either through super input/output (I/O) controller 250 or an I/O controller hub 245. The super I/O controller 250 and the I/O controller hub 245, in turn, can be coupled to a baseboard management controller (BMC) 270 which in turn can be communicatively coupled to a management module 280 for the blade chassis 230. The blade chassis 230 also can provide a network switch 275 linked to switch 265 in each blade server 220. The switch 265, in turn, can be coupled both to a network interface card (NIC) 265 for the blade server 220 and also a universal intelligent data connector (UIDC) 260. The UIDC 260, in turn can be coupled to the BMC 270.

In operation, upon receipt of a proximity event indicating that the systems administrator has moved out of proximity from the blade center, the management module 280 for the blade chassis 230 can be notified. In response, the management module 280 can transmit a signal to each BMC 270 for each supported blade server 220 to secure itself. The BMC 270 in response can transmit a logoff command to the ACPI 240 in the supported operating system 210 via the super I/O controller 250 or the I/O controller hub 245. In this way, each operating system 210 for each blade server 220 in the blade chassis 230 can enter a secure state once the systems administrator has left the proximity of the blade center.

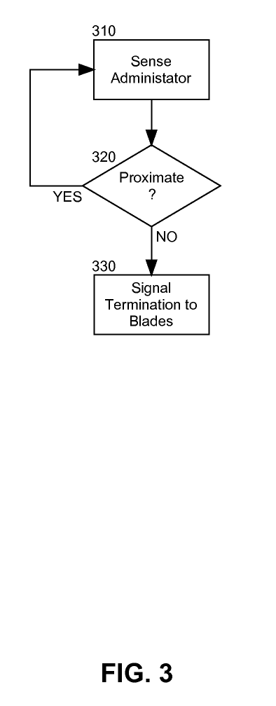

In yet further illustration, FIG. 3 is a flow chart illustrating a process for proximity sensitive blade server security. In block 310, the presence of the administrator can be sensed. For example, a personal article such as a laptop computer, cellular telephone, PDA, earpiece, and the like can transmit a radio signal to the blade center to permit awareness by the blade center of the proximity of the personal article. When the personal article no longer can be detected, it can be presumed that the systems administrator associated with the personal article has moved out of proximity from the blade center. As such, in decision block 320, if the administrator is considered no longer to be proximate to the blade center, in block 330 a termination signal can be forwarded to the blades in the blade center requesting the securing of the respective blades.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for proximity sensitive blade server security, the method comprising:
sensing proximity of a systems administrator relative to a blade center;
detecting a loss of proximity of the systems administrator; and,
triggering automated securing of at least one blade server in the blade server in response to detecting the loss of proximity.

2. The method of claim 1, wherein sensing proximity of a systems administrator relative to a blade center, comprises:
establishing a wireless radio connection with a personal article associated with the systems administrator; and,
determining a loss of proximity when the connection is lost.

3. The method of claim 2, wherein establishing a wireless radio connection with a personal article associated with the systems administrator, comprises establishing a Bluetooth connection with a personal article associated with the systems administrator.

4. The method of claim 2, wherein establishing a wireless radio connection with a personal article associated with the systems administrator, comprises establishing a wireless radio connection with a computing device associated with the systems administrator.

5. The method of claim 1, wherein triggering automated securing of at least one blade server in the blade server in response to detecting the loss of proximity, comprises triggering automated activation of a screen saver in at least one operating system supported by the at least one blade server in the blade server in response to detecting the loss of proximity.

6. The method of claim 1, wherein triggering automated securing of at least one blade server in the blade server in response to detecting the loss of proximity, comprises triggering an automated logoff of the systems administrator from at least one operating system supported by the at least one blade server in the blade server in response to detecting the loss of proximity.

7. A blade center configured for proximity sensitive blade server security, the blade center comprising:
a blade chassis supporting a plurality of blade servers; and,
a proximity detector comprising program code enabled to sense proximity of a systems administrator relative to the blade center, to detect a loss of proximity of the systems administrator, and to trigger automated securing of at least one of the blade servers in response to detecting the loss of proximity.

8. The blade center of claim 7, wherein the proximity detector comprises a short range radio frequency transceiver configured to establish and maintain a short range radio frequency communications link with a personal article.

9. The blade center of claim 8, wherein the short range radio frequency transceiver is a Bluetooth transceiver.

10. The blade center of claim 8, wherein the personal article is an ear piece.

11. The blade center of claim 8, wherein the personal article is a computing device selected from the group consisting of a laptop and a personal digital assistant (PDA).

12. The blade center of claim 8, wherein the personal article is a cellular telephone.

13. A computer program product comprising a computer usable medium embodying computer usable program code for proximity sensitive blade server security, the computer program product comprising:
computer usable program code for sensing proximity of a systems administrator relative to a blade center;
computer usable program code for detecting a loss of proximity of the systems administrator; and,
computer usable program code for triggering automated securing of at least one blade server in the blade server in response to detecting the loss of proximity.

14. The computer program product of claim 13, wherein the computer usable program code for sensing proximity of a systems administrator relative to a blade center, comprises:
computer usable program code for establishing a wireless radio connection with a personal article associated with the systems administrator; and,
computer usable program code for determining a loss of proximity when the connection is lost.

15. The computer program product of claim 14, wherein the computer usable program code for establishing a wireless radio connection with a personal article associated with the systems administrator, comprises computer usable program code for establishing a Bluetooth connection with a personal article associated with the systems administrator.

16. The computer program product of claim 14, wherein the computer usable program code for establishing a wireless radio connection with a personal article associated with the systems administrator, comprises computer usable program code for establishing a wireless radio connection with a computing device associated with the systems administrator.

17. The computer program product of claim 13, wherein the computer usable program code for triggering automated securing of at least one blade server in the blade server in response to detecting the loss of proximity, comprises computer usable program code for triggering automated activation of a screen saver in at least one operating system supported by the at least one blade server in the blade server in response to detecting the loss of proximity.

18. The computer program product of claim 13, wherein the computer usable program code for triggering automated securing of at least one blade server in the blade server in response to detecting the loss of proximity, comprises computer usable program code for triggering an automated logoff of the systems administrator from at least one operating system supported by the at least one blade server in the blade server in response to detecting the loss of proximity.
